(19) United States
(12) Patent Application Publication
(10) Pub. No.: US 2025/0047454 A1
(43) Pub. Date: Feb. 6, 2025

(54) CONFIGURING A BANDWIDTH PART FOR UPLINK AND DOWNLINK

(71) Applicant: Lenovo (Singapore) Pte. Ltd., New Tech Park (SG)

(72) Inventors: Hyejung Jung, Northbrook, IL (US); Vijay Nangia, Woodridge, IL (US); Hossein Bagheri, Urbana, IL (US)

(21) Appl. No.: 18/692,971

(22) PCT Filed: Sep. 15, 2022
(86) PCT No.: PCT/IB2022/058737

§ 371 Date: Mar. 18, 2024

Related U.S. Application Data
(60) Provisional application No. 63/245,409, filed on Sep. 17, 2021.

(51) Int. Cl. H04L 5/00; H04W 72/563

(52) U.S. Cl. CPC H04L 5/0092; H04L 5/0005; H04W 72/563

(57) ABSTRACT

Apparatuses, methods, and systems are disclosed for configuring a bandwidth part for UL and DL. One method includes receiving, at a user equipment (“UE”), information for a bandwidth part (“BWP”) including both a downlink (“DL”) configuration and an uplink (“UL”) configuration. The method includes performing: transmission in a first set of symbols of a first slot according to the UL configuration of the BWP, wherein at least one symbol of the first set of symbols of the first slot includes at least a first UL subband and a first DL subband; reception in a second set of symbols of a second slot according to the DL configuration of the BWP, wherein at least one symbol of the second set of symbols of the second slot includes at least a second UL subband and a second DL subband; or a combination thereof.

### CROSS-REFERENCE TO RELATED APPLICATIONS

This application claims priority to U.S. Patent Application Ser. No. 63/245,409 entitled “APPARATUSES, METHODS, AND SYSTEMS FOR BANDWIDTH PART BASED FULL DUPLEX CELL OPERATION” and filed on Sep. 17, 2021 for Hyejung Jung et al., which is incorporated herein by reference in its entirety.

### FIELD

The subject matter disclosed herein relates generally to wireless communications and more particularly relates to configuring a bandwidth part (“BWP”) for uplink (“UL”) and downlink (“DL”).

### BACKGROUND

In certain wireless communications systems, full duplex communication may be used. In such systems, UL communications and DL communications may be made concurrently.

### BRIEF SUMMARY

Methods for configuring a BWP for UL and DL are disclosed. Apparatuses and systems also perform the functions of the methods. One embodiment of a method includes receiving, at a user equipment (“UE”), information for a BWP including both a DL configuration and an UL configuration. In some embodiments, the method includes performing: transmission in a first set of symbols of a first slot according to the UL configuration of the BWP, wherein at least one symbol of the first set of symbols of the first slot includes at least a first UL subband and a first DL subband; reception in a second set of symbols of a second slot according to the DL configuration of the BWP, wherein at least one symbol of the second set of symbols of the second slot includes at least a second UL subband and a second DL subband; or a combination thereof.

One apparatus for configuring a BWP for UL and DL includes a receiver to receive information for a BWP including both a DL configuration and an UL configuration. In some embodiments, the apparatus includes a processor to perform: transmission in a first set of symbols of a first slot according to the UL configuration of the BWP, wherein at least one symbol of the first set of symbols of the first slot includes at least a first UL subband and a first DL subband; reception in a second set of symbols of a second slot according to the DL configuration of the BWP, wherein at least one symbol of the second set of symbols of the second slot includes at least a second UL subband and a second DL subband; or a combination thereof.

Another embodiment of a method for configuring a BWP for UL and DL includes transmitting, at a network entity, information of a BWP including both a DL configuration and an UL configuration. In some embodiments, the method includes performing: reception in a first set of symbols of a first slot according to the UL configuration of the BWP, wherein at least one symbol of the first set of symbols of the first slot includes at least a first UL subband and a first DL subband; transmission in a second set of symbols of a second slot according to the DL configuration of the BWP, wherein at least one symbol of the second set of symbols of the second slot includes at least a second UL subband and a second DL subband; or a combination thereof.

Another apparatus for configuring a BWP for UL and DL includes a transmitter to transmit information of a BWP including both a DL configuration and an UL configuration. In some embodiments, the apparatus includes a processor to perform: reception in a first set of symbols of a first slot according to the UL configuration of the BWP, wherein at least one symbol of the first set of symbols of the first slot includes at least a first UL subband and a first DL subband; transmission in a second set of symbols of a second slot according to the DL configuration of the BWP, wherein at least one symbol of the second set of symbols of the second slot includes at least a second UL subband and a second DL subband; or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring a BWP for UL and DL;

FIG. 2 is a schematic block diagram illustrating one embodiment of an apparatus that may be used for configuring a BWP for UL and DL;

FIG. 3 is a schematic block diagram illustrating one embodiment of an apparatus that may be used for configuring a BWP for UL and DL;

FIG. 4 is a diagram illustrating one embodiment of a BWP-FullDuplex information element (“IE”);

FIG. 5 is a diagram illustrating one embodiment of a BWP-TDD-UL-DL-Config 1E;

FIG. 6 is a schematic block diagram illustrating one embodiment of BWP configurations for full duplex cell operation;

FIG. 7 is a flow chart diagram illustrating one embodiment of a method for configuring a BWP for UL and DL; and

FIG. 8 is a flow chart diagram illustrating another embodiment of a method for configuring a BWP for UL and DL.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

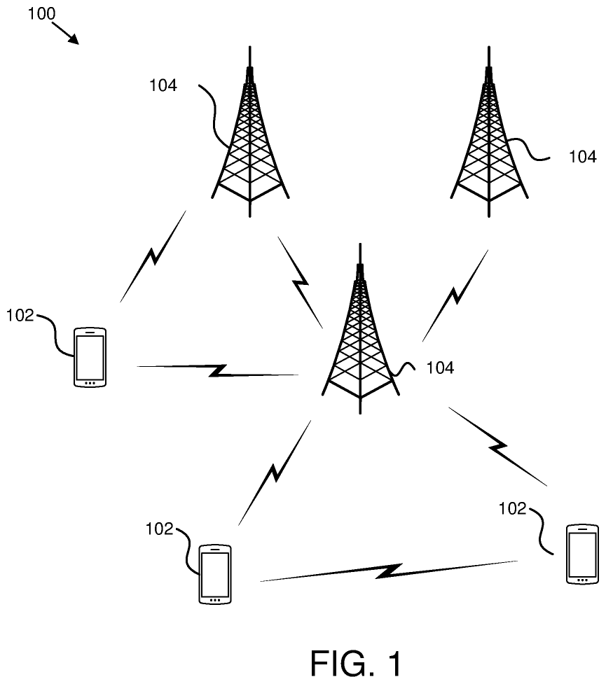

FIG. 1 depicts an embodiment of a wireless communication system 100 for configuring a BWP for UL and DL. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the DL and the remote units 102 transmit on the UL using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive information for a BWP including both a DL configuration and an UL configuration. In some embodiments, the remote unit 102 may perform: transmission in a first set of symbols of a first slot according to the UL configuration of the BWP, wherein at least one symbol of the first set of symbols of the first slot includes at least a first UL subband and a first DL subband; reception in a second set of symbols of a second slot according to the DL configuration of the BWP, wherein at least one symbol of the second set of symbols of the second slot includes at least a second UL subband and a second DL subband; or a combination thereof. Accordingly, the remote unit 102 may be used for configuring a BWP for UL and DL.

In certain embodiments, a network unit 104 may transmit information of a BWP including both a DL configuration and an UL configuration. In some embodiments, the network unit 104 may perform: reception in a first set of symbols of a first slot according to the UL configuration of the BWP, wherein at least one symbol of the first set of symbols of the first slot includes at least a first UL subband and a first DL subband; transmission in a second set of symbols of a second slot according to the DL configuration of the BWP, wherein at least one symbol of the second set of symbols of the second slot includes at least a second UL subband and a second DL subband; or a combination thereof. Accordingly, the network unit 104 may be used for configuring a BWP for UL and DL.

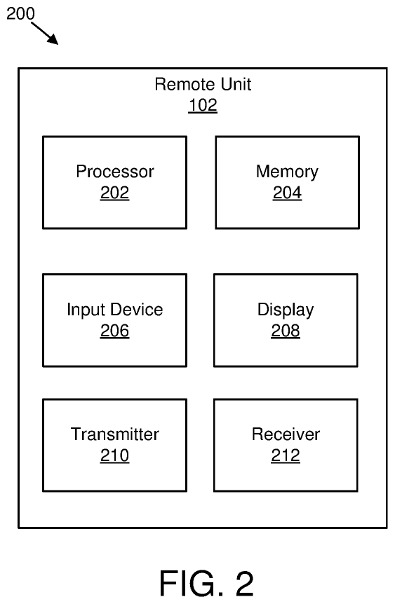

FIG. 2 depicts one embodiment of an apparatus 200 that may be used for configuring a BWP for UL and DL. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 to receive information for a BWP including both a DL configuration and an UL configuration. In some embodiments, the processor 202 to perform: transmission in a first set of symbols of a first slot according to the UL configuration of the BWP, wherein at least one symbol of the first set of symbols of the first slot includes at least a first UL subband and a first DL subband; reception in a second set of symbols of a second slot according to the DL configuration of the BWP, wherein at least one symbol of the second set of symbols of the second slot includes at least a second UL subband and a second DL subband; or a combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

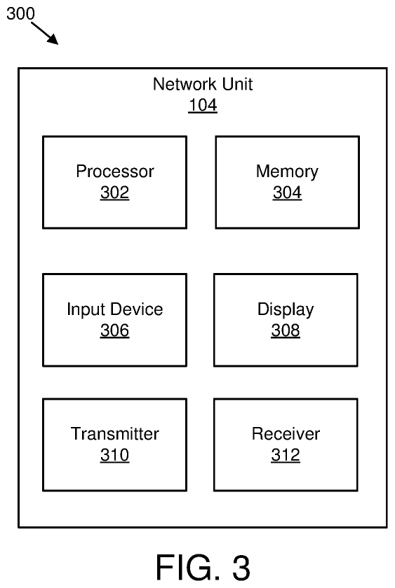

FIG. 3 depicts one embodiment of an apparatus 300 that may be used for configuring a BWP for UL and DL. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 to transmit information of a BWP including both a DL configuration and an UL configuration. In some embodiments, the processor 302 to perform: reception in a first set of symbols of a first slot according to the UL configuration of the BWP, wherein at least one symbol of the first set of symbols of the first slot includes at least a first UL subband and a first DL subband; transmission in a second set of symbols of a second slot according to the DL configuration of the BWP, wherein at least one symbol of the second set of symbols of the second slot includes at least a second UL subband and a second DL subband; or a combination thereof.

It should be noted that one or more embodiments described herein may be combined into a single embodiment.

In certain embodiments, such as in an unpaired spectrum, time division duplex (“TDD”) is used to avoid interference (e.g., UL and DL interference within a network entity and UE-to-UE interference). However, TDD limits UL and DL transmission opportunities and makes it difficult to accommodate urgent UL and DL transmissions simultaneously, especially when DL and UL traffics are asymmetric in a cell. Full duplex operation by a network entity may reduce latency by allowing controlled UL and/or DL (“UL/DL”) transmissions while on-going DL/UL traffics being served in a carrier. To ease the interference handling issue, sub-band based full duplex operation (e.g., one sub-band of a carrier serves UL traffics and another sub-band of the carrier serves DL traffics) in unpaired spectrum may be used.

In some embodiments, there may be methods to support sub-band based full duplex operation in a cell when a serving network entity is capable of simultaneous reception and transmission (e.g., capable of full duplexing with a certain level of self-interference suppression) within a carrier.

In various embodiments, there may be a slot configuration.

If the UE is additionally provided tdd-UL-DL-ConfigurationDedicated, the parameter tdd-UL-DL-ConfigurationDedicated overrides only flexible symbols per slot over the number of slots as provided by tdd-UL-DL-ConfigurationCommon.

The tdd-UL-DL-ConfigurationDedicated provides: 1) a set of slot configurations by slotSpecificConfigurationsToAddModList; 2) for each slot configuration from the set of slot configurations; 3) a slot index for a slot provided by slotindex; and 4) a set of symbols for a slot by symbols where: a) if symbols=allDownlink, all symbols in the slot are DL, b) if symbols=allUplink, all symbols in the slot are UL, and c) if symbols=explicit, nrofDownlinkSymbols provides a number of DL first symbols in the slot and nrofUplinkSymbols provides a number of UL last symbols in the slot. If nrofDownlinkSymbols is not provided, there are no DL first symbols in the slot and if nrofUplinkSymbols is not provided, there are no UL last symbols in the slot. The remaining symbols in the slot are flexible.

In certain embodiments, if a UE is not configured to monitor physical DL control channel (“PDCCH”) for DCI format 2_0, for a set of symbols of a slot that are indicated as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE: 1) the UE receives physical DL shared channel (“PDSCH”) or channel state information (“CSI”) reference signal (“RS”) (“CSI-RS”) in the set of symbols of the slot if the UE receives a corresponding indication by a DCI format; and 2) the UE transmits physical UL shared channel (“PUSCH”), physical UL control channel (“PUCCH”), physical random access channel (“PRACH”), or SRS in the set of symbols of the slot if the UE receives a corresponding indication by a DCI format, a random access request (“RAR”) UL grant, fallbackRAR UL grant, or successRAR.

In some embodiments, for a set of symbols of a slot that are indicated to a UE as flexible by tdd-UL-DL-ConfigurationCommon, and tdd-UL-DL-ConfigurationDedicated if provided, the UE does not expect to receive both dedicated higher layer parameters configuring transmission from the UE in the set of symbols of the slot and dedicated higher layer parameters configuring reception by the UE in the set of symbols of the slot.

In various embodiments, there may be BWP operation. A UE configured for operation in BWPs of a serving cell is configured by higher layers for the serving cell a set of at most four BWPs for receptions by the UE (e.g., DL BWP set) in a DL bandwidth by parameter BWP-Downlink or by parameter initialDownlinkBWP with a set of parameters configured by BWP-DownlinkCommon and BWP-DownlinkDedicated, and a set of at most four BWPs for transmissions by the UE (e.g., UL BWP set) in an UL bandwidth by parameter BWP-Uplink or by parameter initialUplinkBWP with a set of parameters configured by BWP-UplinkCommon and BWP-UplinkDedicated.

If a UE is not provided initialDownlinkBWP, an initial DL BWP is defined by a location and number of contiguous physical review blocks (“PRBs”), starting from a PRB with the lowest index and ending at a PRB with the highest index among PRBs of a control resource set (“CORESET”) for Type0-PDCCH common search space (“CSS”) set, and a subcarrier spacing (“SCS”) and a cyclic prefix for PDCCH reception in the CORESET for Type0-PDCCH CSS set; otherwise, the initial DL BWP is provided by initialDownlinkBWP. For operation on the primary cell or on a secondary cell, a UE is provided an initial UL BWP by initialUplinkBWP. If the UE is configured with a supplementary UL carrier, the UE can be provided an initial UL BWP on the supplementary UL carrier by initialUplinkBWP.

If a UE has dedicated BWP configuration, the UE can be provided by firstActiveDownlinkBWP-Id a first active DL BWP for receptions and by firstActiveUplinkBWP-Id a first active UL BWP for transmissions on a carrier of the primary cell.

In certain embodiments, for each DL BWP or UL BWP in a set of DL BWPs or UL BWPs, respectively, the UE is provided the following parameters for the serving cell: 1) a SCS by subcarrierSpacing; 2) a cyclic prefix by cyclicPrefix; 3) a common resource block (“RB”) N_{BWP}^{start}=O_{carrier}+RBₛₜₐᵣₜ and a number of contiguous RBs N_{BWP}^{size}=L_{RB} provided by locationAndBandwidth that indicates an offset RBₛₜₐᵣₜ and a length L_{RB} as resource indication value (“RIV”), setting N_{BWP}^{size}=275, and a value O_{carrier} provided by offsetToCarrier for the subcarrierSpacing; 4) an index in the set of DL BWPs or UL BWPs by respective BWP-Id; and 5) a set of BWP-common and a set of BWP-dedicated parameters by BWP-DownlinkCommon and BWP-DownlinkDedicated for the DL BWP, or BWP-UplinkCommon and BWP-UplinkDedicated for the UL BWP.

For unpaired spectrum operation, a DL BWP from the set of configured DL BWPs with index provided by BWP-Id is linked with an UL BWP from the set of configured UL BWPs with index provided by BWP-Id when the DL BWP index and the UL BWP index are same. For unpaired spectrum operation, a UE does not expect to receive a configuration where the center frequency for a DL BWP is different than the center frequency for an UL BWP when the BWP-Id of the DL BWP is same as the BWP-Id of the UL BWP.

For each DL BWP in a set of DL BWPs of the PCell, a UE can be configured CORESETs for every type of CSS sets and for UE-specific search space (“USS”). The UE does not expect to be configured without a CSS set on the PCell in the active DL BWP.

If a UE is provided controlResourceSetZero and searchSpaceZero in PDCCH-ConfigSIB1 or PDCCH-ConfigCommon, the UE determines a CORESET for a search space set from controlResourcesetZero, and determines corresponding PDCCH monitoring occasions. If the active DL BWP is not the initial DL BWP, the UE determines PDCCH monitoring occasions for the search space set only if the CORESET bandwidth is within the active DL BWP and the active DL BWP has same SCS configuration and same cyclic prefix as the initial DL BWP.

For each UL BWP in a set of UL BWPs of the PCell or of the PUCCH-SCell, the UE is configured resource sets for PUCCH transmissions.

In some embodiments, a UE receives PDCCH and PDSCH in a DL BWP according to a configured SCS and CP length for the DL BWP. A UE transmits PUCCH and PUSCH in an UL BWP according to a configured SCS and CP length for the UL BWP.

If a BWP indicator field is configured in a DL control information (“DCI”) format, the BWP indicator field value indicates the active DL BWP, from the configured DL BWP set, for DL receptions. If a BWP indicator field is configured in a DCI format, the BWP indicator field value indicates the active UL BWP, from the configured UL BWP set, for UL transmissions. If a BWP indicator field is configured in a DCI format and indicates an UL BWP or a DL BWP different from the active UL BWP or DL BWP, respectively, the UE shall: 1) for each information field in the DCI format, a) if the size of the information field is smaller than the one required for the DCI format interpretation for the UL BWP or DL BWP that is indicated by the BWP indicator, the UE prepends zeros to the information field until its size is the one required for the interpretation of the information field for the UL BWP or DL BWP prior to interpreting the DCI format information fields, respectively, and b) if the size of the information field is larger than the one required for the DCI format interpretation for the UL BWP or DL BWP that is indicated by the BWP indicator, the UE uses a number of least significant bits of the DCI format equal to the one required for the UL BWP or DL BWP indicated by BWP indicator prior to interpreting the DCI format information fields, respectively; and 2) set the active UL BWP or DL BWP to the UL BWP or DL BWP indicated by the BWP indicator in the DCI format.

In various embodiments, a UE does not expect to detect a DCI format with a BWP indicator field that indicates an active DL BWP or an active UL BWP change with the corresponding time domain resource assignment field providing a slot offset value for a PDSCH reception or PUSCH transmission that is smaller than a delay required by the UE for an active DL BWP change or UL BWP change, respectively.

If a UE detects a DCI format with a BWP indicator field that indicates an active DL BWP change for a cell, the UE is not required to receive or transmit in the cell during a time duration from the end of the third symbol of a slot where the UE receives the PDCCH that includes the DCI format in a scheduling cell until the beginning of a slot indicated by the slot offset value of the time domain resource assignment field in the DCI format.

If a UE detects a DCI format with SCell dormancy indication that indicates an active DL BWP change for an Scell in slot n of primary cell, the UE is not required to receive or transmit in the SCell during a time duration.

If a UE detects a DCI format indicating an active UL BWP change for a cell, the UE is not required to receive or transmit in the cell during a time duration from the end of the third symbol of a slot where the UE receives the PDCCH that includes the DCI format in the scheduling cell until the beginning of a slot indicated by the slot offset value of the time domain resource assignment field in the DCI format.

In certain embodiments, a UE does not expect to detect a DCI format indicating an active DL BWP change or an active UL BWP change for a scheduled cell within FR1 (or FR2) in a slot other than the first slot of a set of slots for the DL SCS of the scheduling cell that overlaps with a time duration where the UE is not required to receive or transmit, respectively, for an active BWP change in a different cell from the scheduled cell within FR1 (or FR2).

In some embodiments, a UE expects to detect a DCI format with a BWP indicator field that indicates an active UL BWP change or an active DL BWP change only if a corresponding PDCCH is received within the first 3 symbols of a slot.

For a serving cell, a UE may be provided by defaultDownlinkBWP-Id a default DL BWP among the configured DL BWPs. If a UE is not provided a default DL BWP by defaultDownlinkBWP-Id, the default DL BWP is the initial DL BWP.

If a UE is provided by bwp-InactivityTimer a timer value for the serving cell and the timer is running, the UE decrements the timer at the end of a subframe for FR1 or at the end of a half subframe for FR2 if the restarting conditions are not met during the interval of the subframe for FR1 or of the half subframe for FR2.

For a cell where a UE changes an active DL BWP due to a BWP inactivity timer expiration and for accommodating a delay in the active DL BWP change or the active UL BWP change, the UE is not required to receive or transmit in the cell during a time duration from the beginning of a subframe for FR1, or of half of a subframe for FR2, that is immediately after the BWP inactivity timer expires until the beginning of a slot where the UE can receive or transmit.

When a UE's BWP inactivity timer for a cell within FR1 (or FR2) expires within a time duration where the UE is not required to receive or transmit for an active UL/DL BWP change in the cell or in a different cell within FR1 (or FR2), the UE delays the active UL/DL BWP change triggered by the BWP inactivity timer expiration until a subframe for FR1 or half a subframe for FR2 that is immediately after the UE completes the active UL/DL BWP change in the cell or in the different cell within FR1 (or FR2).

If a UE is provided by firstActiveDownlinkBWP-Id a first active DL BWP and by firstActiveUplinkBWP-Id a first active UL BWP on a carrier of a secondary cell, the UE uses the indicated DL BWP and the indicated UL BWP as the respective first active DL BWP on the secondary cell and first active UL BWP on the carrier of the secondary cell.

In various embodiments, a UE does not expect to monitor PDCCH when the UE performs radio resource management (“RRM”) measurements over a bandwidth that is not within the active DL BWP for the UE.

In certain embodiments, there may be a BWP based full duplex cell operation. In some embodiments of NR, such as for unpaired spectrum operation, a DL BWP from a set of configured DL BWPs with index provided by BWP-Id for a UE is linked with an UL BWP from a set of configured UL BWPs with index provided by BWP-Id for the UE when the DL BWP index and the UL BWP index are same. In such embodiments, for unpaired spectrum operation, a UE does not expect to receive a configuration where the center frequency for a DL BWP is different than the center frequency for an UL BWP when the BWP-Id of the DL BWP is same as the BWP-Id of the UL BWP.

In various embodiments, when a network entity (e.g. gNB) is capable of simultaneous reception and transmission (e.g., capable of full duplexing with a certain level of self-interference suppression) within a carrier, in one implementation, it can configure some UEs in a BWP of a cell to perform UL transmissions (or DL receptions) even though a symbol and/or slot overlapping with the UL transmissions (or the DL receptions) is indicated as a DL (or UL) symbol and/or slot in the BWP of the cell. In one example, the network entity may configure overlapping frequency resources of DL and UL for simultaneous transmission and reception in the cell. In another implementation, a network entity can configure a first subband of a carrier as an UL resource and a second subband of the carrier not overlapping with the first subband as a DL resource for full duplex cell operation within the carrier at least for a certain duration. In a further implementation, a network entity can configure a cell and/or carrier with a first subband of a carrier as an UL resource for a first time duration (e.g., symbol and/or slot) and a second subband of the carrier not overlapping with the first subband as a DL resource for a second time duration with at least a portion of the first time duration overlapping with the second time duration. In a related example, the first and/or second time durations correspond to timer durations (e.g., such as timers associated with full duplex cell operation).

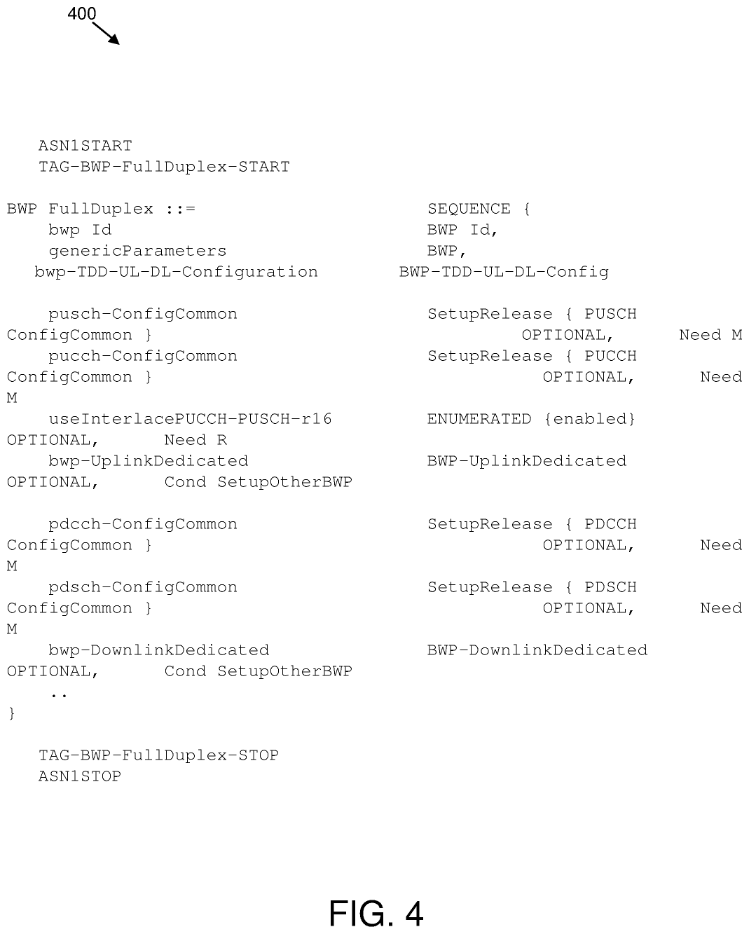

In certain embodiments, there may be BWP-specific time division duplex (“TDD”) UL/DL configuration. In one embodiment, a UE receives a BWP-specific TDD UL/DL configuration (e.g., parameter bwp-TDD-UL-DL-Configuration) in a given BWP configuration. If configured, the BWP-specific TDD UL/DL configuration overrides cell-specific and UE-specific TDD UL/DL configurations (e.g., tdd-UL-DL-ConfigurationCommon and tdd-UL-DL-ConfigurationDedicated) in the corresponding BWP. In one example, the BWP configuration comprises the BWP-specific TDD UL/DL configuration and both UL and DL configurations (e.g., PDCCH, PDSCH, PUSCH, and PUCCH configurations), as shown in FIG. 4. In another example, for unpaired spectrum, the BWP-specific TDD UL/DL configuration configured in an UL (or DL) BWP configuration (e.g., IE BWP-Uplink (or BWP-Downlink)) also applies to a corresponding DL (or UL) BWP with the same BWP-Id.

FIG. 4 is a diagram illustrating one embodiment of a BWP-FullDuplex IE 400. The BWP-FullDuplex IE 400 is used to configure a BWP used for full duplex cell operation.

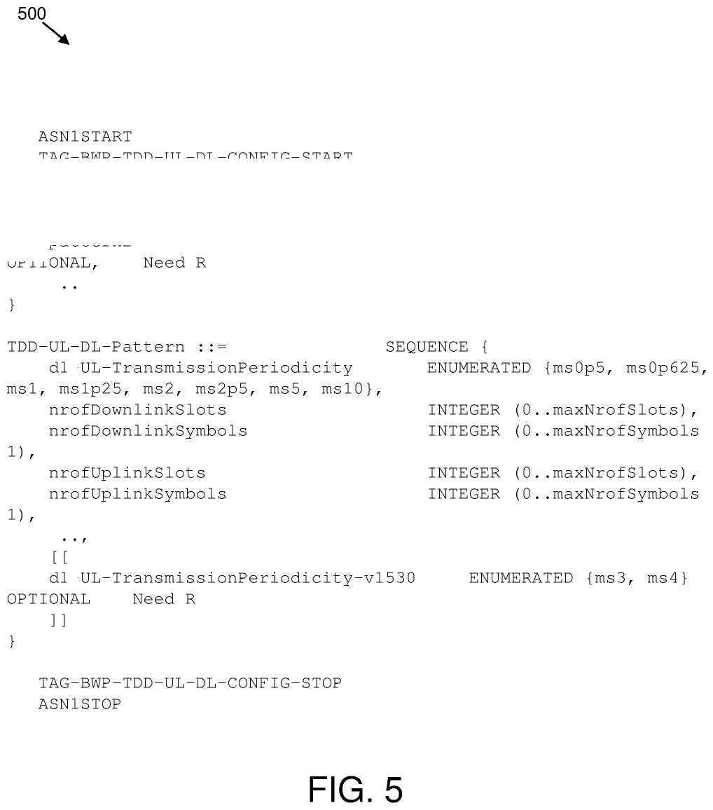

FIG. 5 is a diagram illustrating one embodiment of a BWP-TDD-UL-DL-Config IE 500. The BWP-TDD-UL-DL-Config IE 500 determines the BWP specific UL/DL TDD configuration. A reference SCS used to determine the time domain boundaries in the UL-DL pattern is the same as an SCS configured in a BWP where the BWP-TDD-UL-DL-Config IE 500 is configured (e.g., actual subcarrier spacing for data transmission in the BWP).

In one implementation, if the UE is configured to monitor a DCI format 2_0 in the corresponding BWP for a set of symbols of a slot indicated as DL/UL by bwp-TDD-UL-DL-Configuration, the UE does not expect to detect the DCI format 2_0 with a slot format indicator (“SFI”)-index field value indicating the set of symbols of the slot of the BWP as UL/DL, respectively, or as flexible. In one example, the UE may receive a separate SFI configuration (e.g., a SFI radio network temporary identifier (“RNTI”) (“SFI-RNTI”) value, a DCI payload size, slot format combinations) associated with full duplex cell operation, which is different from a SFI configuration associated with legacy TDD or frequency division duplex (“FDD”) operation.

In another implementation, for a set of symbols of a slot indicated to a UE as flexible by bwp-TDD-UL-DL-Configuration in a DL/UL BWP, if provided, the UE transmits and/or receives or does not transmit and/or receive in the UL/DL BWP according to rules specified for symbols indicated as flexible by tdd-UL-DL-ConfigurationCommon and tdd-UL-DL-ConfigurationDedicated. For example, the UE assumes that flexible symbols in a CORESET (e.g., CORESET symbol indicated as flexible by bwp-TDD-UL-DL-Configuration) configured with a transmission to the UE for PDCCH monitoring in the DL BWP are DL symbols if the UE does not detect an SFI-index field value in DCI format 2_0 indicating the set of symbols of the slot of the BWP as flexible or UL and the UE does not detect a DCI format indicating to the UE to transmit sounding reference signal (“SRS”), PUSCH, PUCCH, or PRACH in the set of symbols.

In one example, a parameter fullDuplex-BWP-TDD-UL-DL-Configuration is configured in a serving cell configuration, ServingCellConfig, and is used to provide a TDD UL/DL configuration for a BWP used for full duplex cell operation.

In yet another implementation, for operation with shared spectrum channel access, if a UE is configured by higher layers to receive a CSI-RS and the UE is provided CO-DurationsPerCell, for a set of symbols of a slot that are indicated as DL or flexible by bwp-TDD-UL-DL-Configuration, the UE cancels the CSI-RS reception in the set of symbols of the slot that are not within the remaining channel occupancy duration.

In one example, the initial DL/UL BWP is not configured with the parameter bwp-TDD-UL-DL-Configuration.

In another example, a UE configured for operation in BWPs of a serving cell is configured by higher layers for the serving cell in which: 1) a first set of at most a first number of BWPs (e.g., four BWPs) for receptions by the UE (e.g., DL BWP set) in a DL bandwidth by parameter BWP-Downlink or by parameter initialDownlinkBWP with a set of parameters configured by BWP-DownlinkCommon and BWP-DownlinkDedicated; 2) a second set of at most a second number of BWPs (e.g., four BWPs) for transmissions by the UE (e.g., UL BWP set) in an UL bandwidth by parameter BWP-Uplink or by parameter initialUplinkBWP with a set of parameters configured by BWP-UplinkCommon and BWP-UplinkDedicated; and 3) a third set of at most a third number of BWPs (e.g., two BWPs) for receptions and transmissions by the UE (e.g., DL-UL BWP set) in a bandwidth by parameter BWP-FullDuplex including the parameter bwp-TDD-UL-DL-Configuration.

In a further example, a UE is configured with a first bwp-InactivityTimer and a second bwp-InactivityTimer. The first bwp-InactivityTimer is applicable to BWPs not associated with frequency division (“FD”) operation (e.g., a BWP provided by parameter BWP-Downlink or parameter BWP-Uplink), and the second bwp-InactivityTimer is applicable to BWPs associated with FD operation (e.g., bwp-Ids corresponding to BWP-FullDuplex IE or a BWP provided by parameter BWP-FullDuplex), wherein if a bwp-InactivityTimer timer is running, the UE decrements the timer at the end of a subframe for FR1 or at the end of a half subframe for FR2 if the restarting conditions are not met during the interval of the subframe for FR1 or of the half subframe for FR2. In one implementation, the UE falls back to a first default BWP if the first bwp-InactivityTimer expires and falls back to a second default BWP if the second bwp-Inactivity Timer expires. In one example, the first and the second default BWPs are the same. In another example, the first default BWP is a BWP not associated with FD operation, and the second default BWP is a BWP associated with FD operation. In another example, the restarting conditions for the first bwp-InactivityTimer and the second bwp-InactivityTimer are different. For instance, the UE restarts the second bwp-InactivityTimer upon receiving a group-common PDCCH with a DCI format or a broadcast signal (e.g., network may send a group common or broadcast signal to extend the FD operation within a cell depending on the UL and DL traffic of users being served in the cell) in a subframe for FR1 or a half subframe for FR2.

In certain embodiments, there may be multiple active BWP based full duplex cell operation.

In one embodiment, a UE receives information of two or more DL BWPs indicated as active DL BWPs, where at least one DL BWP including a first DL BWP is configured for legacy FDD or TDD cell operation, and at least one DL BWP including a second DL BWP is configured for full duplex cell operation. One example of a legacy TDD cell operation is NR dynamic TDD operation. The full duplex cell operation includes at least a network entity that can simultaneously transmit and receive within a carrier. In some embodiments, a UE receives information of two or more UL BWPs indicated as active UL BWPs, where at least one UL BWP including a first UL BWP is configured for legacy FDD (e.g., for paired spectrum) or TDD (e.g., for unpaired spectrum) cell operation and at least one UL BWP including a second UL BWP is configured for full duplex cell operation. In one example, semi-static UL, DL, and/or flexible symbols in the first DL/UL BWPs (e.g., DL/UL BWPs configured for legacy operation) are determined by tdd-UL-DL-ConfigurationCommon (and additionally by tdd-UL-DL-ConfigurationDedicated, if configured), while semi-static UL, DL, and/or flexible symbols in the second DL/UL BWPs (e.g., DL/UL BWPs configured for full duplex operation) are determined by bwp-TDD-UL-DL-Configuration.

In another example, a value of a BWP indicator field configured in a DCI format indicates two or more active DL (or UL) BWPs. In a further example, a UE can be operated with a default DL BWP (e.g., provided by defaultDownlinkBWP-Id or the same as the initial DL BWP) and a default full duplex BWP provided by defaultFullDuplexBWP-Id. In yet another example, a UE is provided by firstActive DownlinkBWP-Id a first active DL BWP (e.g., from the DL BWPs configured for legacy operation) and by secondActiveDownlinkBWP-Id a second active DL BWP (e.g., from the DL BWPs configured for full duplex operation), and by firstActiveUplinkBWP-Id a first active UL BWP (e.g., from the UL BWPs configured for legacy operation) and by secondActiveUplinkBWP-Id a second active UL BWP (e.g., from the UL BWPs configured for full duplex operation) on a carrier of a secondary cell, the UE uses the indicated DL BWPs and the indicated UL BWPs as the respective first and second active DL BWPs on the secondary cell and first and second active UL BWPs on the carrier of the secondary cell.

In a further example, a value of a BWP indicator field configured in a DCI format indicates a first active DL (or UL) BWP. The UE determines a second active DL (or UL) BWP based on the first active DL (or UL) BWP. In one example, a linkage is defined (e.g., via medium access control (“MAC”) control element (“CE”) (“MAC-CE”), radio resource control (“RRC”), or a DCI such as group-common DCI) between the first and the second active DL (or UL) BWPs.

In one implementation, the network entity sets the first DL/UL BWPs (e.g., DL/UL BWPs configured for legacy operation) to be configured with the same center frequency and the same BWP index (e.g., BWP-Id) for half-duplex cell operation in an unpaired spectrum as primary active DL/UL BWPs for the UE. The UE receives a semi-static UL/DL configuration, e.g. tdd-UL-DL-ConfigurationCommon and tdd-UL-DL-ConfigurationDedicated, and may further receive a dynamic SFI in group-common PDCCH, e.g., DCI format 2_0, for UL and DL operations on the primary active DL/UL BWPs. The network entity configures the second UL/DL BWPs (e.g., UL/DL BWPs configured for full duplex operation) as the secondary (or supplementary) active UL/DL BWPs for the UE. The UE is allowed to transmit configured (or dynamically scheduled) one or more UL channels (or signals) on the second UL BWP, when the configured (or dynamically scheduled) one or more UL channels (or signals) overlap in time with at least one DL symbol of the first DL BWP (e.g., overlap with a symbol indicated as DL symbol for the first DL BWP). Similarly, the UE is allowed to receive configured (or dynamically scheduled) one or more DL channels (or signals) on the second DL BWP, when the configured (or dynamically scheduled) one or more DL channels (or signals) overlap in time with at least one UL symbol of the first UL BWP. In one example, the same subcarrier spacing is used in active primary DL/UL BWPs and the secondary UL/DL BWPs within a serving cell.

In one example, the first (e.g., primary) DL BWP and the second (e.g., supplementary) UL BWP are configured to be adjacent in frequency. Further, the first UL BWP and the second DL BWP are configured to be adjacent in frequency. In another example, the second DL and UL BWPs have the same BWP identity and the same center frequency.

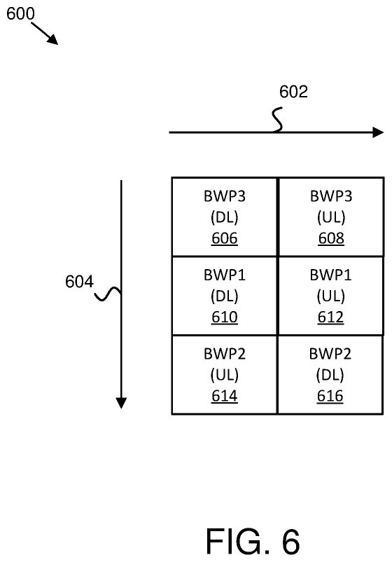

In one implementation, the UE sets an operating frequency band (or operating center frequency and RF filter bandwidth) of its transceiver to include both the first UL BWP and the second DL BWP during the UL region of the first UL BWP so that the UE can switch between transmission on the first UL BWP and reception on the second DL BWP without RF retuning. Additionally or alternatively, the UE sets an operating frequency band of its transceiver to include both the first DL BWP and the second UL BWP during the DL region of the first DL BWP so that the UE can switch between reception on the first DL BWP and transmission on the second UL BWP without RF retuning. The UE may further apply digital-domain filtering for the first DL BWP (and/or the second DL BWP) to suppress in-band interference from the second UL BWP (or from the first UL BWP). For example, as shown in FIG. 6, the UE is indicated with two active BWPs, BWP1 as a primary BWP for conventional TDD operation and BWP2 as a secondary BWP for full duplex cell operation. The operating frequency band of the UE transceiver includes BWP1 and BWP2.

In another example, the first (e.g., primary) DL BWP are the second (e.g., supplementary) UL BWP are configured to be non-contiguous in frequency. Further, the first UL BWP and the second DL BWP are configured to be non-contiguous in frequency.

In another implementation, the UE sets an operating frequency band of its receiver (or transmitter) to include the first DL (or UL) BWP but exclude the second UL (or DL) BWP during the DL (or UL) region of the first DL (or UL) BWP. When the UE switches between reception on the first DL BWP and transmission on the second UL BWP (or switches between transmission on the first UL BWP and reception on the second DL BWP), the UE may retune its local oscillator (“LO”). The UE does not expect to transmit or receive during switching delay, where the switching delay includes RF retuning delay and transmit (“TX”) and/or receive (“RX”) (“TX/RX”) switching delay.

FIG. 6 is a schematic block diagram illustrating one embodiment of BWP configurations 600 for full duplex cell operation. The BWP configurations 600 are illustrated over a time 602 and frequency 604. Moreover, the BWP configurations 600 include a DL BWP3 606 configuration, an UL BWP3 608 configuration, a DL BWP1 610 configuration, an UL BWP1 612 configuration, an UL BWP2 614 configuration, and a DL BWP2 616 configuration.

In yet another implementation, the UE is equipped with separate local oscillators (or RF transceivers) for the first (e.g., primary) DL/UL BWP and the second (supplementary) DL/UL BWP, respectively. When the UE switches between reception on the first DL BWP and transmission on the second UL BWP (or switches between transmission on the first UL BWP and reception on the second DL BWP), there may be no interruption or very little delay. For example, as shown in FIG. 6, the UE is indicated with two active BWPs, BWP3 as a primary BWP for conventional TDD operation and BWP2 as a secondary BWP for full duplex cell operation. UE's one operating frequency band is tuned to BWP3 and another operating frequency band is tuned to BWP2.

In certain embodiments, UE capability information may be configured. In one embodiment, a UE sends a network entity UE capability information that indicates at least one of whether to only support contiguous allocations of a primary DL/UL BWP and a supplementary UL/DL BWP in frequency, to support non-contiguous allocations of the primary DL/UL BWP and the supplementary UL/DL BWP with a first maximum switching delay for switching between reception in the primary DL BWP and transmission in the supplementary UL BWP (or between transmission in the primary UL BWP and reception in the supplementary DL BWP), to support non-contiguous allocations with a second maximum switching delay (e.g., zero switching delay) or to support simultaneous operation in the primary DL/UL BWP and the supplementary UL/DL BWP. In one example, the first maximum switching delay is larger than the second maximum switching delay.

In some embodiments, there may be transmission and/or reception priorities in multiple active BWPs. In one embodiment, if a UE determines overlapping in time of one or more transmission occasions and one or more reception occasions scheduled across multiple active BWPs (e.g., if a transmission (or a reception) on a supplementary BWP overlaps with reception (or a transmission) on a primary BWP), the UE first prioritizes to perform a dynamically scheduled transmission (or reception) (e.g., PUCCH, PUSCH, and/or PDSCH scheduled by DCI or aperiodic CSI-RS, tracking reference signal (“TRS”), and/or SRS triggered by DCI, over a configured transmission (or reception) (e.g., configured grant PUSCH, DL semi-persistent scheduling (“SPS”), periodic or semi-persistent CSI-RS, TRS, SRS, PRACH, and/or MsgA PUSCH). Secondly, if all remaining overlapping transmission occasions and reception occasions are configured transmission and reception occasions or dynamically scheduled transmission and reception occasions, the UE prioritizes to perform a PDSCH reception and/or a PUCCH transmission associated with a higher priority hybrid automatic repeat request (“HARQ”) acknowledgement (“ACK”) (“HARQ-ACK”) codebook and a PUSCH transmission of a higher physical layer priority. Thirdly, if all further remaining overlapping transmission occasions and reception occasions are of the same physical layer priority, the UE further prioritizes to perform a transmission or reception on the primary UL/DL BWP.

In various embodiments, if a UE determines overlapping of scheduled one or more transmission occasions and one or more reception occasions across multiple active BWPs, the UE first selects one or more transmissions or receptions of a higher physical layer priority, secondly selects a dynamically scheduled transmission or reception (e.g., over a configured transmission (or reception)) from the selected one or more transmissions or receptions of the higher physical layer priority. Thirdly, if all remaining overlapping transmission occasions and reception occasions are configured transmission and reception occasions or dynamically scheduled transmission and reception occasions, the UE prioritizes to perform a transmission or reception on the primary UL/DL BWP.

In certain embodiments, a UE does not expect that a dynamically scheduled transmission or reception of a lower physical layer priority in one active UL/DL BWP overlaps in time with configured transmission or reception of a higher physical layer priority in another active UL/DL BWP.

In some embodiments, there may be scheduling in multiple active BWPs. In one embodiment, when a UE receives an indication of multiple active DL/UL BWPs and operates with the multiple active DL/UL BWPs, the UE determines a BWP of a dynamically scheduled PUSCH, PUCCH, and/or PDSCH based on a CORESET and/or search space configuration according to which the UE detects a DCI format corresponding to the dynamically scheduled PUSCH, PUCCH, and/or PDSCH, if a BWP indicator field is not configured in the DCI format. For example, the UE detects a DCI format scheduling a PUSCH in a CORESET configured in a primary active DL BWP, the UE assumes that the PUSCH is scheduled in a primary active UL BWP. In another example, the UE detects a DCI format scheduling a PDSCH in a CORESET configured in a secondary active DL BWP, the UE assumes that the PDSCH is scheduled in the secondary active DL BWP and a PUCCH for a corresponding HARQ-ACK feedback is scheduled in a secondary active UL BWP. In other examples, the CORESET and/or search space configuration can include an indication of a target active DL/UL BWP for dynamically scheduled PUSCH, PUCCH, and/or PDSCH. In another example, a linkage is defined between the BWP of the PDCCH scheduling PDSCH, PUSCH, and/or PUCCH and the BWP of the scheduled PDSCH, PUSCH, and/or PUCCH. In one example, a PDCCH-config provides the BWP ID of the scheduled PDSCH, PUSCH, and/or PUCCH. In another example, a MAC-CE indicates the linkage.

In another embodiment, when a UE receives an indication of multiple active DL/UL BWPs and operates with the multiple active DL/UL BWPs, the UE determines a BWP of a dynamically scheduled PUSCH, PUCCH, and/or PDSCH based on a BWP indicator field configured in a corresponding DCI format.

In some embodiments, the terms antenna, panel, and antenna panel are used interchangeably. An antenna panel may be hardware that is used for transmitting and/or receiving radio signals at frequencies lower than 6 GHZ (e.g., frequency range 1 (“FR1”)), or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from one or more spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a RF chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on implementation, a “panel” can have at least one of the following functionalities as an operational role of unit of antenna group to control its transmit (“TX”) beam independently, unit of antenna group to control its transmission power independently, unit of antenna group to control its transmission timing independently. The “panel” may be transparent to another node (e.g., next hop neighbor node). For certain condition(s), another node or network entity can assume the mapping between device's physical antennas to the logical entity “panel” may not be changed. For example, the condition may include until the next update or report from device or comprise a duration of time over which the network entity assumes there will be no change to the mapping. Device may report its capability with respect to the “panel” to the network entity. The device capability may include at least the number of “panels”. In one implementation, the device may support transmission from one beam within a panel; with multiple panels, more than one beam (one beam per panel) may be used for transmission. In another implementation, more than one beam per panel may be supported and/or used for transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4) ‘QCL-TypeD’: {Spatial Rx parameter}. Other QCL-Types may be defined based on combination of one or large-scale properties.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mmWave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during a transmission occasion) and a source reference signal (e.g., synchronization signal and physical broadcast channel block (“SSB”), CSI-RS, and/or SRS) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

Described herein are methods to support sub-band based full duplex operation in a cell when a serving network entity is capable of simultaneous reception and transmission (e.g., capable of full duplexing with a certain level of self-interference suppression) within a carrier.

In various embodiments, there may be multiple active BWP based full duplex cell operation, which may include: 1) the UE receives information of two active DL/UL BWPs, a primary DL/UL BWP configured for legacy TDD or FDD cell operation and a supplementary DL/UL BWP configured for full duplex cell operation, where the supplementary DL/UL BWP includes a BWP-specific TDD UL/DL configuration; 2) the UE is allowed to transmit/receive one or more UL/DL channels/signals on the supplementary UL/DL BWP, when the one or more UL/DL channels/signals overlap in time with at least one DL/UL symbol of the primary DL/UL BWP; 3) the UE sends a network entity UE capability information that indicates whether: a) to only support contiguous allocations of the primary DL/UL BWP and the supplementary UL/DL BWP in frequency, b) to support non-contiguous allocations of the primary DL/UL BWP and the supplementary UL/DL BWP with a first maximum switching delay for switching between the primary DL/UL BWP and the supplementary UL/DL BWP, c) to support non-contiguous allocations with a second maximum switching delay (e.g. zero switching delay), or d) to support simultaneous operation in the primary DL/UL BWP and the supplementary UL/DL BWP; and 4) the UE determines overlapping of scheduled one or more transmission occasions and one or more reception occasions across multiple active BWPs, the UE first selects one or more transmissions or receptions of a higher physical layer priority, secondly selects a dynamically scheduled transmission or reception, and thirdly, prioritizes to perform a transmission or reception on the primary UL/DL BWP.

In certain embodiments, a UE does not transmit/receive on cell-specifically configured or group specifically indicated DL/UL symbols. Furthermore, a UE can transmit/receive on cell-specifically configured or group specifically indicated flexible symbols if the UE receives a dynamic indication to transmit/receive on the flexible symbols.

In some embodiments, a BWP-based full duplex cell operation framework allows a network entity to configure various modes of full duplex cell operation such as non-overlapping sub-band based, overlapping sub-band based, or fully overlapping band full duplex cell operation, based on a deployment scenario and an expected interference level.

In various embodiments, a method in a UE comprises: receiving information of a primary active DL/UL BWP and a secondary active DL/UL BWP, where the secondary active DL/UL BWP is configured with a BWP-specific TDD UL/DL configuration; and performing at least one selected from: transmission in a first set of symbols of a slot of the secondary active UL BWP, where at least one symbol of the first set of symbols of the slot overlaps with a downlink symbol of the primary active DL BWP; and reception in a second set of symbols of the slot of the secondary active DL BWP, where at least one symbol of the second set of symbols of the slot overlaps with an uplink symbol of the primary active UL BWP.

In certain embodiments, the primary active DL/UL BWP is associated with a cell-specific TDD UL/DL configuration.

In some embodiments, the method includes sending UE capability information, wherein the UE capability information comprises an indication selected from: to only support contiguous allocations of the primary active DL/UL BWP and the secondary active UL/DL BWP in frequency; to support non-contiguous allocations of the primary DL/UL BWP and the secondary UL/DL BWP with a first maximum switching delay for switching between the primary DL/UL BWP and the secondary UL/DL BWP; to support non-contiguous allocations of the primary DL/UL BWP and the secondary UL/DL BWP with a second maximum switching delay for switching between the primary DL/UL BWP and the secondary UL/DL BWP, wherein the second maximum switching delay is smaller than the first maximum switching delay; and to support simultaneous operation in the primary DL/UL BWP and the supplementary UL/DL BWP.

In various embodiments, the second maximum switching delay is zero.

In certain embodiments, the method includes: determining overlapping of one or more transmission occasions and one or more reception occasions across the primary active DL/UL BWP and the secondary active UL/DL BWP; selecting at least one transmission or reception of a higher priority index from the one or more transmission occasions and the one or more reception occasions; selecting at least one dynamically scheduled transmission or reception from the at least one transmission or reception of the higher priority index; selecting a transmission or reception scheduled on the primary active UL/DL BWP from the at least one dynamically scheduled transmission or reception; and performing the transmission or reception on the primary active UL/DL BWP.

In some embodiments, the method includes: detecting a DCI format on a control resource set, wherein the DCI format comprises scheduling information of a physical channel; determining a BWP, where reception or transmission of the physical channel occurs, based on the control resource set.

In various embodiments, a bandwidth part indicator field is not configured in the DCI format.

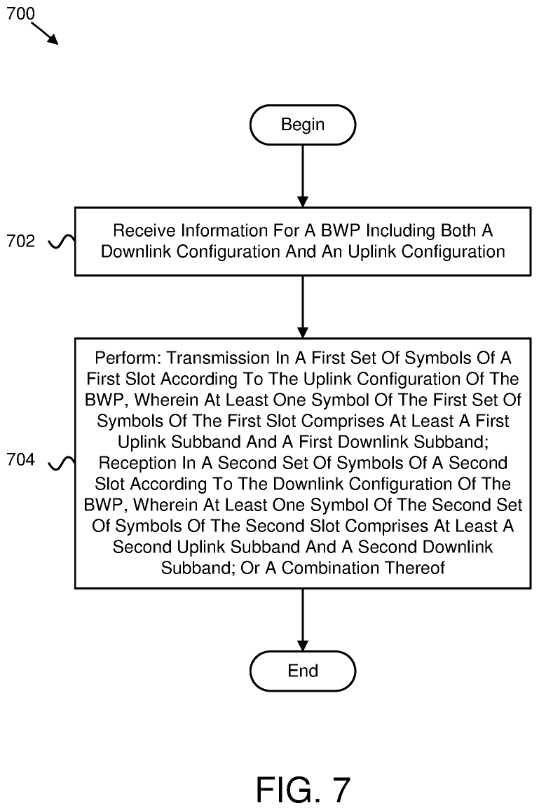

FIG. 7 is a flow chart diagram illustrating one embodiment of a method 700 for configuring a BWP for UL and DL. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 receiving 702 information for a BWP including both a DL configuration and an UL configuration. In some embodiments, the method 700 includes performing 704: transmission in a first set of symbols of a first slot according to the UL configuration of the BWP, wherein at least one symbol of the first set of symbols of the first slot includes at least a first UL subband and a first DL subband; reception in a second set of symbols of a second slot according to the DL configuration of the BWP, wherein at least one symbol of the second set of symbols of the second slot includes at least a second UL subband and a second DL subband; or a combination thereof.

In certain embodiments, the DL configuration comprises a PDCCH configuration, a PDSCH configuration, or a combination thereof. In some embodiments, the UL configuration comprises a PUCCH configuration, a PUSCH configuration, or a combination thereof. In various embodiments, the transmission in the first set of symbols of the first slot is within the first UL subband.

In one embodiment, the method 700 further comprises: determining that at least one transmission occasion in the first UL subband overlaps in time with at least one reception occasion in the first DL subband; selecting at least one transmission or reception of a higher priority index from the at least one transmission occasion and the at least one reception occasion; selecting at least one dynamically scheduled transmission or reception from the at least one transmission or reception of the higher priority index; and performing a transmission or reception of the at least one dynamically scheduled transmission or reception. In certain embodiments, the first UL subband and the second DL subband are associated with the BWP.

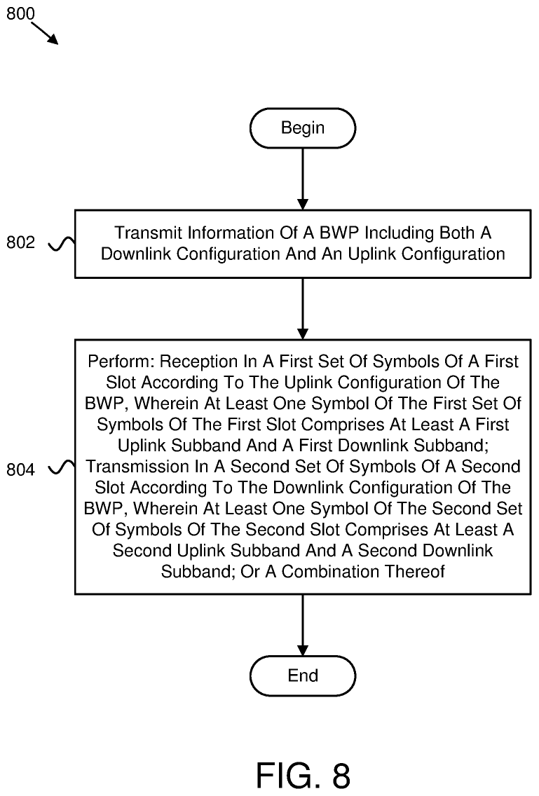

FIG. 8 is a flow chart diagram illustrating another embodiment of a method 800 for configuring a BWP for UL and DL. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes transmitting 802 information of a BWP including both a DL configuration and an UL configuration. In some embodiments, the method 800 includes performing 804: reception in a first set of symbols of a first slot according to the UL configuration of the BWP, wherein at least one symbol of the first set of symbols of the first slot includes at least a first UL subband and a first DL subband; transmission in a second set of symbols of a second slot according to the DL configuration of the BWP, wherein at least one symbol of the second set of symbols of the second slot includes at least a second UL subband and a second DL subband; or a combination thereof.

In certain embodiments, the DL configuration comprises a PDCCH configuration, a PDSCH configuration, or a combination thereof. In some embodiments, the UL configuration comprises a PUCCH configuration, a PUSCH configuration, or a combination thereof. In various embodiments, the reception in the first set of symbols of the first slot is within the first UL subband.

In one embodiment, the method 800 further comprises: determining that at least one reception occasion for a UE in the first UL subband overlaps in time with at least one transmission occasion for the UE in the first DL subband; selecting at least one reception or transmission of a higher priority index from the at least one reception occasion and the at least one transmission occasion for the UE; selecting at least one dynamically scheduled reception or transmission from the at least one reception or transmission of the higher priority index; and performing a reception or transmission of the at least one dynamically scheduled reception or transmission for the UE. In certain embodiments, the first DL subband and the second UL subband are associated with the BWP.

In one embodiment, an apparatus comprises: a receiver to receive information for a BWP including both a DL configuration and an UL configuration; and a processor to perform: transmission in a first set of symbols of a first slot according to the UL configuration of the BWP, wherein at least one symbol of the first set of symbols of the first slot comprises at least a first UL subband and a first DL subband; reception in a second set of symbols of a second slot according to the DL configuration of the BWP, wherein at least one symbol of the second set of symbols of the second slot comprises at least a second UL subband and a second DL subband; or a combination thereof.

In certain embodiments, the DL configuration comprises a PDCCH configuration, a PDSCH configuration, or a combination thereof.

In some embodiments, the UL configuration comprises a PUCCH configuration, a PUSCH configuration, or a combination thereof.

In various embodiments, the transmission in the first set of symbols of the first slot is within the first UL subband.

In one embodiment, the processor further to: determine that at least one transmission occasion in the first UL subband overlaps in time with at least one reception occasion in the first DL subband; select at least one transmission or reception of a higher priority index from the at least one transmission occasion and the at least one reception occasion; select at least one dynamically scheduled transmission or reception from the at least one transmission or reception of the higher priority index; and perform a transmission or reception of the at least one dynamically scheduled transmission or reception.

In certain embodiments, the first UL subband and the second DL subband are associated with the BWP.

In one embodiment, a method at a UE, the method comprises: receiving information for a BWP including both a DL configuration and an UL configuration; and performing: transmission in a first set of symbols of a first slot according to the UL configuration of the BWP, wherein at least one symbol of the first set of symbols of the first slot comprises at least a first UL subband and a first DL subband; reception in a second set of symbols of a second slot according to the DL configuration of the BWP, wherein at least one symbol of the second set of symbols of the second slot comprises at least a second UL subband and a second DL subband; or a combination thereof.

In certain embodiments, the DL configuration comprises a PDCCH configuration, a PDSCH configuration, or a combination thereof.

In some embodiments, the UL configuration comprises a PUCCH configuration, a PUSCH configuration, or a combination thereof.

In various embodiments, the transmission in the first set of symbols of the first slot is within the first UL subband.

In one embodiment, the method further comprises: determining that at least one transmission occasion in the first UL subband overlaps in time with at least one reception occasion in the first DL subband; selecting at least one transmission or reception of a higher priority index from the at least one transmission occasion and the at least one reception occasion; selecting at least one dynamically scheduled transmission or reception from the at least one transmission or reception of the higher priority index; and performing a transmission or reception of the at least one dynamically scheduled transmission or reception.

In certain embodiments, the first UL subband and the second DL subband are associated with the BWP.

In one embodiment, an apparatus comprises: a transmitter to transmit information of a BWP including both a DL configuration and an UL configuration; and a processor to perform: reception in a first set of symbols of a first slot according to the UL configuration of the BWP, wherein at least one symbol of the first set of symbols of the first slot comprises at least a first UL subband and a first DL subband; transmission in a second set of symbols of a second slot according to the DL configuration of the BWP, wherein at least one symbol of the second set of symbols of the second slot comprises at least a second UL subband and a second DL subband; or a combination thereof.

In certain embodiments, the DL configuration comprises a PDCCH configuration, a PDSCH configuration, or a combination thereof.

In some embodiments, the UL configuration comprises a PUCCH configuration, a PUSCH configuration, or a combination thereof.

In various embodiments, the reception in the first set of symbols of the first slot is within the first UL subband.

In one embodiment, the processor further to: determine that at least one reception occasion for a UE in the first UL subband overlaps in time with at least one transmission occasion for the UE in the first DL subband; select at least one reception or transmission of a higher priority index from the at least one reception occasion and the at least one transmission occasion for the UE; select at least one dynamically scheduled reception or transmission from the at least one reception or transmission of the higher priority index; and perform a reception or transmission of the at least one dynamically scheduled reception or transmission for the UE.

In certain embodiments, the first DL subband and the second UL subband are associated with the BWP.

In one embodiment, a method at a network entity, the method comprises: transmitting information of a BWP including both a DL configuration and an UL configuration; and performing: reception in a first set of symbols of a first slot according to the UL configuration of the BWP, wherein at least one symbol of the first set of symbols of the first slot comprises at least a first UL subband and a first DL subband; transmission in a second set of symbols of a second slot according to the DL configuration of the BWP, wherein at least one symbol of the second set of symbols of the second slot comprises at least a second UL subband and a second DL subband; or a combination thereof.

In certain embodiments, the DL configuration comprises a PDCCH configuration, a PDSCH configuration, or a combination thereof.

In some embodiments, the UL configuration comprises a PUCCH configuration, a PUSCH configuration, or a combination thereof.

In various embodiments, the reception in the first set of symbols of the first slot is within the first UL subband.

In one embodiment, the method further comprises: determining that at least one reception occasion for a UE in the first UL subband overlaps in time with at least one transmission occasion for the UE in the first DL subband; selecting at least one reception or transmission of a higher priority index from the at least one reception occasion and the at least one transmission occasion for the UE; selecting at least one dynamically scheduled reception or transmission from the at least one reception or transmission of the higher priority index; and performing a reception or transmission of the at least one dynamically scheduled reception or transmission for the UE.

In certain embodiments, the first DL subband and the second UL subband are associated with the BWP.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive information for a bandwidth part (BWP) including both a downlink (DL) configuration and an uplink (UL) configuration; and
perform transmission in a first set of symbols of a first slot according to the UL configuration of the BWP, wherein at least one symbol of the first set of symbols of the first slot comprises at least a first UL subband and a first DL subband;
perform reception in a second set of symbols of a second slot according to the DL configuration of the BWP, wherein at least one symbol of the second set of symbols of the second slot comprises at least a second UL subband and a second DL subband;
or a combination thereof.

2. The UE of claim 1, wherein the DL configuration comprises a physical DL control channel (PDCCH) configuration, a physical DL shared channel (PDSCH) configuration, or a combination thereof.

3. The UE of claim 1, wherein the UL configuration comprises a physical UL control channel (PUCCH) configuration, a physical UL shared channel (PUSCH) configuration, or a combination thereof.

4. The UE of claim 1, wherein the transmission in the first set of symbols of the first slot is within the first UL subband.

5. The UE of claim 1, wherein the at least one processor is configured to cause the UE to:
determine that at least one transmission occasion in the first UL subband overlaps in time with at least one reception occasion in the first DL subband;
select at least one transmission or reception of a higher priority index from the at least one transmission occasion and the at least one reception occasion;
select at least one dynamically scheduled transmission or reception from the at least one transmission or reception of the higher priority index; and
perform a transmission or reception of the at least one dynamically scheduled transmission or reception.

6. The UE of claim 1, wherein the first UL subband and the second DL subband are associated with the BWP.

7. A method performed by a user equipment (UE), the method comprising:
receiving information for a bandwidth part (BWP) including both a downlink (DL) configuration and an uplink (UL) configuration; and
performing:
transmission in a first set of symbols of a first slot according to the UL configuration of the BWP, wherein at least one symbol of the first set of symbols of the first slot comprises at least a first UL subband and a first DL subband;
reception in a second set of symbols of a second slot according to the DL configuration of the BWP, wherein at least one symbol of the second set of symbols of the second slot comprises at least a second UL subband and a second DL subband;
or a combination thereof.

8. The method of claim 7, wherein the DL configuration comprises a physical DL control channel (PDCCH) configuration, a physical DL shared channel (PDSCH) configuration, or a combination thereof.

9. The method of claim 7, wherein the UL configuration comprises a physical UL control channel (PUCCH) configuration, a physical UL shared channel (PUSCH) configuration, or a combination thereof.

10. A base station, comprising:
at least one memory; and
at least one processor coupled with the at least one memory and configured to cause the base station to:
transmit information of a bandwidth part (BWP) including both a downlink (DL) configuration and an uplink (UL) configuration; and
perform reception in a first set of symbols of a first slot according to the UL configuration of the BWP, wherein at least one symbol of the first set of symbols of the first slot comprises at least a first UL subband and a first DL subband;
perform transmission in a second set of symbols of a second slot according to the DL configuration of the BWP, wherein at least one symbol of the second set of symbols of the second slot comprises at least a second UL subband and a second DL subband;
or a combination thereof.

11. The base station of claim 10, wherein the DL configuration comprises a physical DL control channel (PDCCH) configuration, a physical DL shared channel (PDSCH) configuration, or a combination thereof.

12. The base station of claim 10, wherein the UL configuration comprises a physical UL control channel (PUCCH) configuration, a physical UL shared channel (PUSCH) configuration, or a combination thereof.

13. The base station of claim 10, wherein the reception in the first set of symbols of the first slot is within the first UL subband.

14. The base station of claim 10, wherein the at least one processor further is configured to cause the base station to:
determine that at least one reception occasion for a user equipment (UE) in the first UL subband overlaps in time with at least one transmission occasion for the UE in the first DL subband;
select at least one reception or transmission of a higher priority index from the at least one reception occasion and the at least one transmission occasion for the UE;
select at least one dynamically scheduled reception or transmission from the at least one reception or transmission of the higher priority index; and
perform a reception or transmission of the at least one dynamically scheduled reception or transmission for the UE.

15. The base station of claim 10, wherein the first DL subband and the second UL subband are associated with the BWP.

16. A processor for wireless communication, comprising:
at least one controller coupled with at least one memory and configured to cause the processor to:
receive information for a bandwidth part (BWP) including both a downlink (DL) configuration and an uplink (UL) configuration; and
perform transmission in a first set of symbols of a first slot according to the UL configuration of the BWP, wherein at least one symbol of the first set of symbols of the first slot comprises at least a first UL subband and a first DL subband;
perform reception in a second set of symbols of a second slot according to the DL configuration of the BWP, wherein at least one symbol of the second set of symbols of the second slot comprises at least a second UL subband and a second DL subband;
or a combination thereof.

17. The processor of claim 16, wherein the DL configuration comprises a physical DL control channel (PDCCH) configuration, a physical DL shared channel (PDSCH) configuration, or a combination thereof.

18. The processor of claim 16, wherein the UL configuration comprises a physical UL control channel (PUCCH) configuration, a physical UL shared channel (PUSCH) configuration, or a combination thereof.

19. The processor of claim 16, wherein the transmission in the first set of symbols of the first slot is within the first UL subband.

20. The processor of claim 16, wherein the at least one controller is configured to cause the processor to:
determine that at least one transmission occasion in the first UL subband overlaps in time with at least one reception occasion in the first DL subband;
select at least one transmission or reception of a higher priority index from the at least one transmission occasion and the at least one reception occasion;
select at least one dynamically scheduled transmission or reception from the at least one transmission or reception of the higher priority index; and
perform a transmission or reception of the at least one dynamically scheduled transmission or reception.
